(19) United States
(12) Patent Application Publication
(10) Pub. No.: US 2025/0183796 A1
(43) Pub. Date: Jun. 5, 2025

(54) FIELD DEVICE FOR PROCESS AUTOMATION, SYSTEM AND METHOD

(71) Applicant: Festo SE & Co. KG, Esslingen (DE)

(72) Inventor: Steffen WUNDERLICH, Aichtal (DE)

(21) Appl. No.: 18/966,884

(22) Filed: Dec. 3, 2024

(30) Foreign Application Priority Data
Dec. 5, 2023 (DE) 102023133959.1

(51) Int. Cl. H02M 3/155

(52) U.S. Cl. CPC H02M 3/155

(57) ABSTRACT

A field device for process automation, including a current interface with which the field device can be connected onto a function unit in order to receive an interface current, further including a load circuit which is designed to provide a load circuit voltage on the basis of at least a part of the interface current. The load circuit includes a voltage limiter, the voltage limiter including a load which is designed as a controllable load or as a Z-diode and being designed to limit the load circuit voltage by way of a first electronic control element which is controlled by the load, and the load circuit further includes a longitudinal voltage stabiliser which is formed by way of the load and which is designed to provide a supply voltage on the basis of the load circuit voltage amid the use of the load.

### CROSS-REFERENCE

This application claims the benefit of German application DE 102023133959.1, filed Dec. 5, 2023, which is incorporated herein by reference.

The invention relates to a field device for process automation, comprising a current interface with which the field device is connectable to a function unit in order to receive an interface current, further comprising a load circuit which is designed to provide a load circuit voltage on the basis of at least a part of the interface current, wherein the load circuit comprises a voltage limiter, said voltage limiter comprising a load which is designed as a controllable load or as a Z-diode and being designed to limit the load circuit voltage by way of a first electronic control element which is controlled by the load.

A field device with a current interface and with a load circuit is known from DE 10 2019 215 409 B4. The load circuit comprises a voltage limiter with a controllable load which controls a transistor. The load circuit voltage which drops across the load circuit is provided as a supply voltage.

### SUMMARY OF THE INVENTION

An object of the invention lies in achieving an improved stabilisation of the supply voltage in an efficient manner.

This object is achieved by a field device according to claim 1. The load circuit further comprises a longitudinal voltage stabiliser which is formed by way of the load and which is designed to provide a supply voltage on the basis of the load circuit voltage amid the use of the load.

An improved stabilisation of the supply voltage can be achieved by the longitudinal voltage stabiliser. That load which is already present for the control of the first electronic control element is used as a load for the longitudinal voltage stabiliser. Thus no additional load is necessary and the improved stabilisation can consequently be effected in an efficient manner.

Preferably, the longitudinal voltage stabiliser comprises a second electronic control element which is controlled by the load, and is designed to provide the supply voltage amid use of the second electronic control element.

Preferably, the first electronic control element is a first transistor and/or the second electronic control element a second transistor.

Preferably, the load circuit further comprises a current limiter which has a third electronic control element, in particular a third transistor. The current limiter is preferably designed to control the first electronic control element amid the use of the third electronic control element, in order to limit a first load circuit current which flows through the first electronic control element.

Preferably, the longitudinal voltage stabiliser is designed to reduce or prevent an influence of an increase of the load circuit voltage on the supply voltage, said increase being caused by the current limiter on limiting the first load circuit current.

Preferably, the load comprises an output terminal, with which the load controls the first electronic control element as well as the second electronic control element.

Preferably, the load is designed as a controllable load and comprises an input terminal which is controlled on the basis of the supply voltage.

Preferably, the load circuit comprises an output branch which comes from the supply terminal and onto which a/the input terminal of the controllable load is connected.

Preferably, the output branch comprises a voltage divider which provides a part-voltage on the basis of the supply voltage, said part-voltage being fed to the input terminal.

Preferably, the load circuit comprises a first load circuit connection point and a second load circuit connection point, between which connection points the load circuit voltage drops. The voltage limiter preferably comprises an input branch which runs from the first load circuit connection point to the second load circuit connection point and comprises the first electronic control element.

The longitudinal voltage stabiliser preferably comprises a load branch which by way of example is connected parallel to the input branch and comprises the load.

Preferably, the field device comprises a measuring resistor which in particular is connected in series with the load circuit. The field device is preferably designed to receive communication information from the function unit amid the use of the measuring resistor, said communication information being transmitted via the interface current.

Preferably, the field device comprises a consumer, wherein the field device is designed to provide at least a part of the energy which is required for operation of the consumer, by way of the supply voltage and on the basis of the interface current.

The invention further relates to a system, comprising a field device as well as a function unit, wherein the function unit is connected to the current interface.

The invention further relates to a method for operating the system, comprising the steps: receiving, at the field device, the interface current from the function unit, providing, by way of the load circuit, the load circuit voltage on the basis of at least a part of the interface current, limiting the load circuit voltage by way of the voltage limiter, and providing a supply voltage on the basis of the load circuit voltage by way of the longitudinal voltage stabiliser.

### BRIEF DESCRIPTION OF DRAWINGS

Exemplary details and embodiments are hereinafter explained with reference to the FIGURE. Herein is shown:

FIG. 1 a schematic representation of a system of a function unit and a field device.

### DETAILED DESCRIPTION OF INVENTION

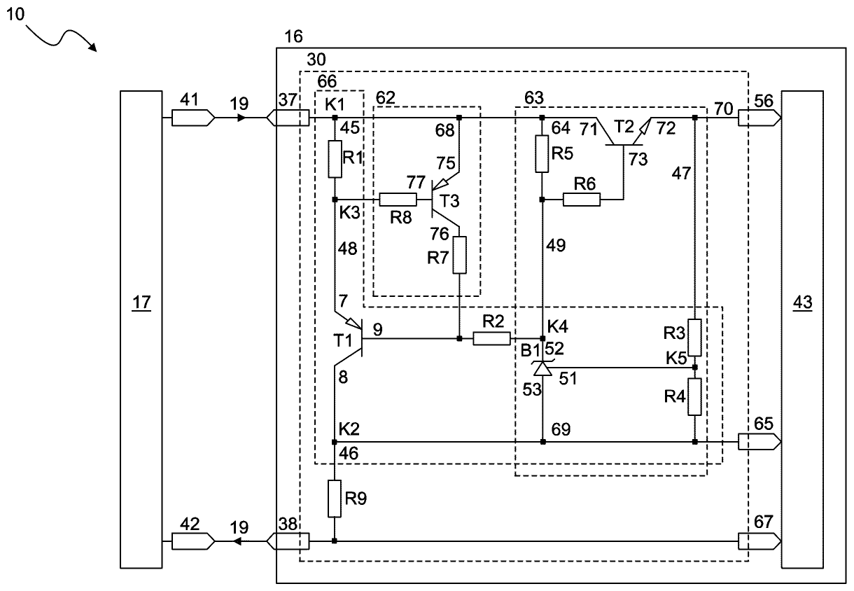

FIG. 1 shows a system 10 which comprises a function unit 17 and a field device 16. The function unit 17 is connected to the current interface of the field device 16 in FIG. 1. The field device 16 is preferably a position regulator, in particular for process automation.

According to a possible embodiment, the system 10 further comprises a (not shown in the FIGURE) valve (and/or a valve drive). The valve and/or the valve drive is actuated by the field device 16. The system 10 is for example an industrial facility, in particular a process technology facility.

The system 10 serves as an exemplary application environment of the field device 16. The field device 16 can also be provided on its own—thus in particular without the other components of the system 10.

The function unit 17 is designed for example as a sensor, actuator or as a super-ordinate control. For example, the function unit 17 is a sensor which is designed as an active current sensor. By way of example, the function unit 17 is a path sensor. The function unit 17 expediently comprises its own function unit housing and is preferably arranged distanced to the field device 16.

The function unit 17 comprises a first function unit connection point 41 and a second function unit connection point 42, with which connection points the function unit 17 is connected to a current interface of the field device 16. The function unit 17 provides an interface current 19 which by way of example flows from the first function unit connection point 41 (via the field device 16) to the second function unit connection point 42.

The function unit 17 is expediently designed to transmit communication information, for example a sensor value, in particular a measurement value, or a control value, in particular a setpoint, to the field device 16 via the interface current 19. The field device 16 is preferably designed to carry out an action, for example an actuation of the valve and/or of the valve drive according to the communication information.

The communication between the function unit 17 and the field device 16 is preferably effected via the current strength of the interface current 19. For example, the function unit 17 maps the communication information which is to be transmitted to the field device 16, to the current strength of the interface current 19.

The function unit 17 is expediently further designed to supply the field device 16 with energy, optionally with the complete electrical energy which is available to the field device 16, via the interface current 19.

The function unit 17 and the field device 16 are expediently connected to one another via electrical leads, for example one or more cables. By way of example, a first electrical lead runs from the first control connection point 41 to a first interface connection point 37 of the field device 16 and a second electrical lead runs from the second control connection point 42 to a second interface connection point 38 of the field device 16.

The field device 16 comprises the current interface with which the field device 16 is connected (or connectable) to the function unit 17, in order to receive the interface current 19. Preferably, the field device 16 is communicatively connected to the function unit 17 via the current interface. The current interface is preferably a 4-20 mA current interface. By way of example, the current interface is an analogue current interface. The current circuit which is formed by the function unit 17 and the current interface can also be denoted as a current loop.

In particular, the field device 16 is implemented in 2-wire technology, wherein the current interface represents the 2-wire terminal. Optionally, the current interface is the single electricity supply of the field device 16. According to one possible embodiment, the field device 16 comprises a further (not shown in the FIGURE) current interface, in particular for connection to a super-ordinate control, for example to a PLC (programmable logic controller). In this case, the field device can be commonly supplied with electricity by the two current interfaces, or also only by one of the two current interfaces.

The field device 16 expediently comprises a consumer 43. The consumer 43 is supplied (in particular exclusively) by the electrical energy which is provided via the current interface. The consumer 43 is preferably processing electronics for processing communication information.

As already mentioned, the field device 16 in particular serves for actuating a valve (and/or a valve drive). Preferably, the field device 16 is designed as a position controller and in particular comprises an electro-pneumatic transducer, in order to provide a pneumatic actuation signal for actuating the valve (and/or the valve drive). According to a possible embodiment, the consumer comprises the electro-pneumatic transducer. Optionally, the consumer 43 comprises a pilot valve, in particular a magnet valve. Preferably, the consumer 43 can comprise a field device control unit, in particular a processor, for example a microcontroller.

The field device 16 comprises a coupling device 30 with which the field device is connected (or can be connected) onto the function unit 17. The coupling device 30 comprises the current interface. By way of example, the field device 16 has its own field device housing, in which in particular the coupling device 30 and/or the consumer 43, for example the processing electronics, are arranged. Expediently, the field device 16 is fastened with its field device housing to the valve (or to the valve drive), for example by way of a mechanical interface which is arranged on the field device housing.

The field device 16 comprises a load circuit which by way of example is part of the coupling device 30. The load circuit is designed to provide a load circuit voltage on the basis of at least part of the interface current 19 (expediently on the basis of the complete interface current 19). The load circuit voltage in particular results as a product of that part of the interface current 19 (preferably the complete interface current 19) which flows from the first load circuit connection point 45 to a second load circuit connection point 46, and the resistance which acts between the first load circuit connection point 45 and the second load circuit connection point 46. The load circuit voltage expediently lies at a first circuit node K1 (with respect to a reference potential).

The load circuit further comprises a voltage limiter 66 which comprises a load B1 which is designed as a controllable load or as a Z-diode. The voltage limiter 66 is designed to limit the load circuit voltage by way of a first electronic control element T1 which is controlled by the load B1. Expediently, the load circuit carries out a closed-loop control of the load circuit voltage by way of a voltage limiter.

The load circuit further comprises a longitudinal voltage stabiliser 63 which is formed by way of the load B1 and which is designed to provide a supply voltage on the basis of the load circuit voltage amid the use of the load B1. The supply voltage by way of example is present at a supply terminal 56 (in respect to the reference potential). The longitudinal voltage stabiliser 63 in particular is connected between the first circuit node K1 and the supply terminal 56. The load B1 is part of the voltage limiter 66 as well as part of the longitudinal voltage stabiliser 63. In particular, a voltage stabiliser concerning which the output voltage (here the supply voltage) is separated (here by way of example by a second electronic control element T2) from the input voltage (here the load circuit voltage) is denoted as a longitudinal voltage stabiliser 63.

The field device 16 is preferably designed to provide at least a part of the energy which is necessary for the operation of the consumer 43 (or the complete energy which is required for operation of the consumer 43) on the basis of the interface current 19 by way of the supply voltage. In particular, the consumer is fed with electrical energy by the supply voltage which is present at the supply terminal 56.

The coupling device 30 comprises the first interface connection point 37 and the second interface connection point 38, with which connection points the field device 16 is connected to the function unit 17. The coupling device 30 further comprises the supply terminal 56 as well as a reference potential terminal 65, between which terminals the supply voltage is provided. The consumer 43 is connected onto the supply terminal 56 and onto the reference potential terminal 65. The reference potential terminal 65 is for example a ground terminal. The reference potential, for example ground is provided at the reference potential terminal 65. The coupling device 30 further comprises a communication terminal 76 at which the coupling device 30 by way of example provides a measuring voltage which corresponds to the communication information (in particular with respect to the reference potential terminal 65).

The field device 16, in particular the coupling device 30 comprises a measuring resistor R9 which is connected in series with the load circuit (and can also be denoted as a ninth resistor R9). The field device 16 is designed, amid the use of the measuring resistor R9, to receive the communication information which is transmitted via the interface current 19, from the function unit 17. By way of example, the interface current 19 is led via the measuring resistor R9 and the communication information is detected by the consumer 43 on the basis of the measuring voltage which drops across the measuring resistor R9.

The load circuit comprises a first load circuit connection point 45 and a second load circuit connection point 46, with which connection points the load circuit is connected between the interface connection points 37, 38 in particular in series with the measuring resistor R9. The interface current 19 flows through the load circuit from the first load circuit connection point 45 to the second load circuit connection point 46. The load circuit voltage drops between the first load circuit connection point 45 and the second load circuit connection point 46.

The first load circuit connection point 45, the first interface connection point 37, a first voltage stabiliser connection point 64 as well as a first current limiter connection point 68 by way of example are connected to the first circuit node K1 in a direct manner. The first load circuit connection point 45, the first interface connection point 37, the first voltage stabiliser connection point 64 as well as the first current limiter connection point 68 by way of example lie at the same potential—the potential of the first circuit node K1.

The second load circuit connection point 46 by way of example lies at the reference potential, in particular at the ground potential. Expediently, the second load circuit connection point 46 is connected (in particularly directly) to the reference potential terminal 65, in particular to a ground terminal. The second load circuit connection point 46 and/or a second voltage stabiliser connection point 69 is directly connected to a second circuit node K2 and lies at the potential of the second circuit node K2.

The voltage limiter 66 is to be dealt with in more detail hereinafter. The voltage limiter 66 in particular is designed as a shunt voltage limiter.

By way of example, the voltage limiter 66 comprises an input branch 48 which runs from the first load circuit connection point 45 to the second load circuit connection point 46 and comprises the first electronic control element T1. By way of example, the first electronic control element T1 is a first transistor. The first transistor by way of example is designed as a bipolar transistor, in particular as a PNP transistor.

A first load circuit current flows through the input branch 48—and herewith through the first electronic control element T1. The first load circuit current is a part of the interface current 19 which flows through the load circuit. The input branch 48 serves for setting the first load circuit current, in particular increasing it and specifically via the first electronic control element T1, for limiting the load circuit voltage.

The first electronic control element T1 is controlled by the load B1, by way of example by way of a first load output terminal 52 (by way of example via a second resistor R2) being connected to a control terminal 9 of the first electronic control element T1. By way of example, the first load circuit current is determined by the control of the first electronic control element T1 by the load B1.

The input branch 48 by way of example comprises a first resistor R1 which is connected in series with the first electronic control element T1. The input branch 48 comprises the third circuit node K3 which by way of example is arranged between the first electronic control element T1 and the first resistor R1.

The first electronic control element T1 comprises a first current leading terminal 7, a second current leading terminal 8 and the control terminal 9. The first current leading terminal 7 by way of example is connected onto the first resistor R1. The second current leading terminal 8 by way of example is connected onto the second load circuit connection point 46. The control terminal 9 is connected (by way of example via the second resistor R2) onto a fourth circuit node K4. By way of example, the first current leading terminal 7 is an emitter terminal, the second current leading terminal 8 a collector terminal and the control terminal 9 a base terminal.

The voltage limiter 66 comprises the load B1, which by way of example is connected between the fourth circuit node K4 and the second circuit node K2. The voltage limiter 66 further comprises a voltage divider which is formed from a third resistor R3 and a fourth resistor R4.

Preferably, the load circuit B1 comprises an output branch 47 which comes from the supply terminal 56 and onto which a load input terminal 51 of the load B1 is connected. The output branch 47 comprises the voltage divider which on the basis of the supply voltage provides a part-voltage which is fed to the load input terminal 51. The output branch 47 comprises a fifth circuit node K5, onto which the load input terminal 51 is connected. The fifth circuit node is arranged between the third resistor R3 and the fourth resistor R4.

The load B1 comprises the first load output terminal 51 and the second load output terminal 53. The first load output terminal 52 can also be denoted as a cathode and the second load output terminal 53 can also be denoted as an anode. The load input terminal 51 can also be denoted as a reference terminal. The first load output terminal 52 is connected onto the control terminal 9 of the transistor T1, by way of example via the second resistor R2. The load B1 with the first load output terminal 52 controls the first electronic control element T1. The second load output terminal 53 is connected onto the second circuit node K2.

The load B1 is designed to set the current which flows from the first load output terminal 52 to the second load output terminal 53 (and which can also be denoted as the second load circuit current), on the basis of the voltage which is present at the load input terminal 51—by way of example of the part-voltage which is provided by the voltage divider. In particular, the load B1 is designed to compare the voltage which is present at the load input terminal 51 with a reference voltage, for example an internal reference voltage and to set the second load circuit current on the basis of the comparison. The reference voltage is for example 2.5 V. For example, the load B1 is designed to increase the second load circuit current as a reaction to the voltage which is present at the load input terminal 51 being larger than the reference voltage. Furthermore, the load B1 is expediently designed to reduce the second load circuit current as a reaction to the voltage which is present at the load input terminal 51 being smaller than the reference voltage.

Preferably, with the load B1, the current/voltage characterise curve between the first and the second load output terminal 52, 53 is changed via a control of the load input terminal 51. For example, the load B1 is a shunt voltage regulator or a shunt voltage regulator. For example, the component Zetex ZHT431 of the company Diodes Incorporated can be used as a load B1, or a component which has the same function as this component, for example the component “TL431”. The load B1 is designed for example as an adjustable precision Zener shunt regulator. The load B1 can also be denoted as an adjustable Z-diode. The load B1 in particular is a reference diode. The load B1 preferably serves as a voltage reference.

The longitudinal voltage stabiliser 63 is dealt with in more detail hereinafter.

Preferably, the longitudinal voltage stabiliser 63 is designed to reduce or prevent an influence of an increase of the load circuit voltage on the supply voltage, said increase being caused by a (subsequently explained in more detail) current limiter 62 on limiting the first load circuit current.

The longitudinal voltage stabiliser 63 in particular is designed as a longitudinal voltage regulator. In particular, the longitudinal voltage stabiliser 63 is designed to close-loop control the supply voltage to a predefined voltage value.

The longitudinal voltage stabiliser 63 comprises the first voltage stabiliser connection point 64, the second voltage stabiliser connection point 69 and a third voltage stabiliser connection point 70. The longitudinal voltage stabiliser 63 is connected to the supply terminal 56 with the third voltage stabiliser connection point 70.

The longitudinal voltage stabiliser 63 comprises a load branch 49 which by way of example runs from the first voltage stabiliser connection point 64 to the second voltage stabiliser connection point 69. The second load circuit current flows through the load branch 49. The second load circuit current is part of the interface current 19 which flows through the load circuit. The load branch 49 by way of example is connected in parallel to the input branch 48 and comprises the load B1. The load branch 49 further comprises a fifth resistor R5 which is connected between the fourth circuit node K4 and the first circuit node K1.

The longitudinal voltage stabiliser 63 preferably comprises a second electronic control element T2 which is controlled by the load B1, and is designed to provide, in particular closed-loop control the supply voltage amid the use of the second electronic control element T2. By way of example, the load B1 controls the second electronic control element T2 with its first load output terminal 52. The second electronic control element T2 in particular is a second transistor. The second transistor by way of example is designed as a bipolar transistor, in particular as an NPN transistor.

The second electronic control element T2 comprises a first current leading terminal 71, a second current leading terminal 72 and a control terminal 73. The first current leading terminal 71 by way of example is connected onto the first voltage stabiliser connection point 64. The second current leading terminal 72 by way of example is connected onto the third voltage stabiliser connection point 70—and herewith onto the supply terminal 56. The control terminal 73 is connected onto the fourth circuit node K4 (by way of example via a sixth resistor R6). By way of example, the first current leading terminal 71 is a collector terminal, the second current leading terminal 72 an emitter terminal and the control terminal 73 a base terminal.

The longitudinal voltage stabiliser 63 comprises the output branch 47 which runs from the third voltage stabiliser connection point 70 to the second voltage stabiliser connection point 69 and by way of example comprises the voltage divider which is formed from the third resistor R3 and the fourth resistor R4.

Preferably, the load circuit further comprises the load limiter 62 which comprises a third electronic control element T3, in particular a third transistor. The current limiter 62 is designed to control the first electronic control element T1 amid the use of a third electronic control element T3, in order to limit the first load circuit current which flows through the first electronic control element T1.

The third electronic control element T3 by way of example is designed as a bipolar transistor, in particular as a PNP transistor.

The third electronic control element T3 comprises a first current leading terminal 75, a second current leading terminal 76 and a control terminal 77. The first current leading terminal 75 by way of example is connected onto the first current limiter connection point 68. The second current leading terminal 76 is (by way of example via a seventh resistor R7) connected to the control terminal 9 of the first electronic control element T1. The control terminal 77 is connected to the third circuit node K3 (by way of example via an eighth resistor R8).

By way of example, the first current leading terminal 75 is an emitter terminal, the second current leading terminal 76 a collector terminal and the control terminal 77 a base terminal.

According to a possible embodiment, the coupling device 30, in particular the load circuit is designed with a polarity which is reversed compared to the embodiment which is shown in FIG. 1. For example, with this possible embodiment, the first electronic control element T1 and the third electronic control element T3 are each designed as NPN transistors and the second electronic control element T2 is designed as a PNP transistor.

Moreover, according to a possible embodiment, one, several or all of the electronic control elements T1, T2, T3 can be designed as field effect transistors, in particular as metal oxide semiconductor field effect transistors.

The operation of the system 10 is dealt with hereinafter.

On operation, the field device 16 receives the interface current 19 from the function unit 17 and by way of the load circuit provides the load circuit voltage on the basis of at least a part of the interface current 19. The voltage limiter 66 limits the load circuit voltage and the longitudinal voltage stabiliser 63 provides the supply voltage on the basis of the load circuit voltage. The load circuit expediently functions as a voltage source for the consumer 43. The load circuit in particular represents a low-impedance device.

Expediently, the load circuit closed-loop controls the supply voltage to a predefined voltage value by way of the longitudinal voltage stabiliser. The predefined voltage value by way of example can be set via the third resistor R3 and the fourth resistor R4, in particular via the resistance ratio of these two resistors. For example, the set supply voltage is 3V. In particular, the load voltage which drops across the load B1 can be set via the resistance ratio. The supply voltage results for example from the load voltage and the base emitter voltage of the second transistor, in particular as a difference or sum of the load voltage and this base-emitter voltage.

Preferably, the load circuit further closed-loop controls the load circuit voltage to a predefined voltage value, in particular by way of the voltage limiter 66.

In particular, by way of the longitudinal voltage stabiliser 63, it is possible to prevent the field device 16 from being damaged if it is in correctly connected with its current interface, for example if the field device 16 with its current interface is (incorrectly) connected onto a voltage source with too high a voltage, e.g. a 24V supply voltage. If instead of the longitudinal voltage stabiliser, a simple Z-diode were to be used, then in the case of an error, thus e.g. given the connection of a 24V supply voltage, a short-circuit and excess current would arise and the Z-diode (and/or the ninth resistor R9) would be destroyed.

Concerning the present load circuit, in the case of an error, concerning which too high an interface current 19 is present or too high a voltage is connected at the current interface (thus e.g. given the connection of an unsuitable 24V between the first interface connection point 37 and the second interface connection point 38) firstly the first load circuit current through the first electronic control element T1 would increase. With an increasing first load circuit current, the current limiter 62 by way of the third electronic control element T3 leads more current and controls the first electronic control element T1 in a manner such that the first load circuit current no longer rises or drops. By way of example, the current limiter 62 has the effect that given an increasing first load circuit current, the voltage at the control terminal 9 of the first transistor T1 increases, by which means the first transistor T1 closes and the first load circuit current is reduced. This leads to the load circuit voltage, in particular the voltage which is present at the first node K1 increasing. For example, from a certain load circuit voltage, the load circuit is no longer capable of closed-loop controlling the load circuit voltage to its predefined voltage value. The increase of the load circuit voltage is compensated by way of the longitudinal voltage stabiliser to the extent that the influence of this increase on the supply voltage is reduced or prevented. Hence even given an increasing load circuit voltage (which can no longer be limited by the voltage limiter 66), an increase of the supply voltage at the supply terminal 56 can be reduced or prevented and expediently a stable supply voltage can be provided.

It is to be noted that the applied terms “first”, “second”, “third” etc. merely serve for providing the respective components with an unambiguous reference. It is not to be implied by such terms as to how many components are present. Thus the term “eight resistor” is not to imply that there are necessarily eight resistors.

1. A field device for process automation, comprising a current interface with which the field device is connectable to a function unit in order to receive an interface current, wherein the field device further comprises a load circuit which is designed to provide a load circuit voltage on the basis of at least a part of the interface current, wherein the load circuit comprises a voltage limiter, wherein the voltage limiter comprises a load which is designed as a controllable load or as a Z-diode, and the voltage limiter is designed to limit the load circuit voltage by way of a first electronic control element which is controlled by the load, and wherein the load circuit further comprises a longitudinal voltage stabiliser which is formed using the load and which is designed to provide, using the load, a supply voltage on the basis of the load circuit voltage.

2. The field device according to claim 1, wherein the longitudinal voltage stabiliser comprises a second electronic control element which is controlled by the load, and the longitudinal voltage stabiliser is designed to provide the supply voltage using the second electronic control element.

3. The field device according to claim 1, wherein the first electronic control element is a first transistor and/or the second electronic control element is a second transistor.

4. The field device according to claim 1, wherein the load circuit further comprises a current limiter which comprises a third electronic control element, wherein the current limiter is designed to control, using the third electronic control element, the first electronic control element in order to limit a first load circuit current which flows through the first electronic control element.

5. The field device according to claim 4, wherein the longitudinal voltage stabiliser is designed to reduce or prevent an influence of an increase of the load circuit voltage on the supply voltage, said increase being caused by the current limiter when limiting the first load circuit current.

6. The field device according to claim 2, wherein the load comprises a load output terminal with which the load controls the first electronic control element as well as the second electronic control element.

7. The field device according to claim 1, wherein the load is designed as a controllable load and comprises a load input terminal which is controlled on the basis of the supply voltage.

8. The field device according to claim 1, wherein the load circuit comprises an output branch which comes from the supply terminal and to which a load input terminal of the controllable load is connected.

9. The field device according claim 8, wherein the output branch comprises a voltage divider which on the basis of the supply voltage provides a part-voltage which is fed to the load input terminal.

10. The field device according to claim 1, wherein the load circuit comprises a first load circuit connection point and a second load circuit connection point, between which connection points the load circuit voltage drops, wherein the voltage limiter comprises an input branch which runs from the first load circuit connection point to the second load circuit connection point and comprises the first electronic control element.

11. The field device according to claim 10, wherein the longitudinal voltage stabiliser comprises a load branch which is connected in parallel to the input branch and comprises the load.

12. The field device according to claim 1, further comprising a measuring resistor which is connected in series with the load circuit, wherein the field device is designed to receive, using the measuring resistor, communication information, which is transmitted via the interface current, from the function unit.

13. The field device according to claim 1, further comprising a consumer, wherein the field device is designed to provide at least a part of the energy which is required for the operation of the consumer by way of the supply voltage on the basis of the interface current.

14. A system, comprising a field device according to claim 1, as well as the function unit, wherein the function unit is connected to the current interface.

15. A method for operating the system according to claim 14, comprising the steps: receiving, at the field device, the interface current from the function unit, providing, by way of the load circuit, the load circuit voltage on the basis of at least a part of the interface current, limiting the load circuit voltage by way of the voltage limiter, providing a supply voltage on the basis of the load circuit voltage by way of the longitudinal voltage stabiliser.

16. The field device according to claim 4, wherein the third electronic control element is a third transistor.
